(19) United States
(12) Patent Application Publication
(10) Pub. No.: US 2026/0283130 A1
(43) Pub. Date: Sep. 24, 2026

(54) FISHING SINKER

(71) Applicant: FLORIDA ATLANTIC UNIVERSITY BOARD OF TRUSTEES, Boca Raton, FL (US)

(72) Inventors: Stephen Kajiura, Boca Raton, FL (US); Kieran Smith, St. Paul, MN (US)

(21) Appl. No.: 19/570,556

(22) Filed: Mar. 18, 2026

Related U.S. Application Data
(60) Provisional application No. 63/774,869, filed on Mar. 20, 2025.

(51) Int. Cl. A01K 95/02

(52) U.S. Cl. CPC A01K 95/02

(57) ABSTRACT

A sinker assembly includes a sinker and a sleeve removably coupled to a body of the sinker. The body of the sinker being constructed of a material with a first galvanic corrosion potential in salt water. The sinker having a line receiving channel extending along a longitudinal axis of the body. The sleeve includes a body portion defining a receiving aperture that is sized to receive the body of the sinker. The body portion being formed of a material with a second galvanic corrosion potential in the salt water that is different from the first galvanic corrosion potential. The difference between the first galvanic corrosion potential of the sinker and the second galvanic corrosion potential of the sleeve results in a voltage gradient in the salt water that stimulates an electrosensory system of an electrosensitive organism in the salt water.

### CROSS REFERENCE

This application claims the priority benefit of U.S. Provisional Patent Application No. 63/774,869 filed Mar. 20, 2025, which is incorporated herein by reference in its entirety.

### FIELD OF THE DISCLOSURE

The present disclosure relates generally to a sinker for fishing. In particular, the disclosure is directed towards a sinker having a quick attachment and detachment mechanism. In some implementations, the sinker is made with multiple materials with dissimilar galvanic potentials, such as zinc and graphite, as a repellent or deterrent for altering the behavior of electro-sensitive organisms. In a general application, this sinker can be used for the purpose of reducing elasmobranch bycatch in commercial and recreational fishing.

### BACKGROUND OF THE DISCLOSURE

Technological advancements in commercial fishing gear have allowed international fleets to substantially increase both their range and catch per unit effort, CPUE (Kennelly and Broadhurst, 2002). However, improved CPUE results in a concomitant increase in unwanted, non-target species, or bycatch. The US National Oceanic and Atmospheric Administration (NOAA) National Marine Fisheries Service defines bycatch as, "discarded catch of any living marine resource plus retained incidental catch and unobserved mortality due to a direct encounter with fishing gear". In pelagic longline fisheries, impacted animals include sea birds, sea turtles, marine mammals, non-targeted teleost fish, and elasmobranchs (Lewison et al., 2004).

Elasmobranchs fishes (sharks, skates, and rays) constitute a large percentage of bycatch throughout much of the world's pelagic longline fisheries. Approximately 25% of the catch on US longline vessels between 1992-2003 consisted of elasmobranchs (Abercrombie et al., 2005). Alarmingly, these catch rates are comparable to that of target species, such as swordfish and tuna, and could potentially lead to massive declines in shark populations. Due to the late maturation and low fecundity of most shark species relative to teleost fishes, they are considered highly susceptible to overfishing and drastic declines in numbers could prove catastrophic to the overall health and vitality of our oceans. As a result, it is of great importance to mitigate bycatch of elasmobranchs in pelagic longline fisheries in ways that do not impact catch rates of target species.

Although the target species and elasmobranch bycatch are trophically similar, only the elasmobranchs possess an electrosensory system. Elasmobranchs utilize their highly developed electrosensory system to facilitate prey capture, predator detection, communication, and possibly for use in navigation (Kalmijn, 1982; Tricas and Sisneros, 2004; Tricas et al., 1995; Coombs et al., 2002). Because teleost species targeted by commercial longline fishing lack electrosensory systems, recent work has investigated whether electric stimuli can be employed to deter sharks from biting baited hooks (Kaimmer and Stoner, 2008; Stoner and Kaimmer, 2008; Wang et al., 2008; Brill et al., 2009; Tallack and Mandelman, 2009; Robbins et al., 2011; Jordan et al., 2011; McCutcheon and Kajiura, 2012). These studies have focused on the naturally electrogenic lanthanide elements (electropositive metals) as potential shark deterrents.

Lanthanide elements have been proposed as potential shark deterrents. They are highly reactive when immersed in seawater and readily undergo dissolution by means of hydrolysis. This process generates voltage which is within a range detectable by the elasmobranch electrosensory system. Studies have shown this voltage is strong enough to alter the behavior of elasmobranchs and reduce catch rates of sharks, skates, and rays on hooks treated with lanthanide elements (Kaimmer and Stoner, 2008; Stoner and Kaimmer, 2008; Wang et al., 2008; Brill et al., 2009).

Certain shortcomings exist when using lanthanide metals for shark deterrents or repellents. Lanthanide metals undergo rapid dissolution and have been shown to lose up to 70% of their mass in just 40 hours of soak time (Stoner and Kaimmer 2008). As a result, the metals must be replaced often.

Increased demand for lanthanide elements for use in electronics has dramatically increased prices. For example, in 2026, the lanthanide metal neodymium ranged in price from US $157.00 - $221.00 kg⁻¹. The price for neodymium rose by 240% since January 2020. As a result, the economic feasibility of lanthanide elements for use as sacrificial shark deterrents in commercial and recreational fishing is considerably diminished. Lanthanide metals are also highly reactive when machined, producing filings and dust that are extremely flammable.

Based on the rapid dissolution, cost, and high reactivity, the adoption of lanthanide metals for commercial application is quite limited, making the development of less hazardous, cheaper alternatives desirable.

Magnets have also been proposed as potential shark deterrents. Permanent magnets create localized magnetic fields, and as the shark swims near the magnet, an electric field is induced via electromagnetic induction (O’Connell et al, 2010). Sharks are thought to detect these localized electric fields through their electrosensory system. Results from the peer reviewed scientific literature are mixed, with magnets deemed effective at repelling sharks in some studies but ineffective in others.

Shark deterrent magnets are often made from neodymium, a rare earth element, which is expensive and has a non-homogeneous distribution worldwide. Countries rich in neodymium can control supply and dictate market price.

Magnets stick to fishing tackle, fishing equipment, other magnets, and the fishing vessel hull. This makes them unsuitable for application in commercial fishing operations.

### SUMMARY

In some aspects, the disclosure relates to a sinker assembly configured to be coupled to a fishing line. The sinker assembly comprises a sinker including a body having a first end portion, a second end portion opposite the first end portion, and a main body portion connecting the first and second end portions. The body being constructed of a material with a first galvanic corrosion potential in salt water. The body includes a line receiving channel extending along a longitudinal axis of the body between the first end portion and the second end portion. The sinker assembly also comprises a sleeve removably coupled to the body of the sinker. The sleeve includes a body portion defining a receiving aperture that is sized to receive the body of the sinker. The body portion being formed of a material with a second galvanic corrosion potential in the salt water that is different from the first galvanic corrosion potential. The difference between the first galvanic corrosion potential of the sinker and the second galvanic corrosion potential of the sleeve results in a voltage gradient in the salt water that stimulates an electrosensory system of an electrosensitive organism in the salt water. The sleeve includes a line receiving slot extending along a length of the body portion. The line receiving slot configured to receive the fishing line to facilitate attachment of the sleeve to the sinker.

In some aspects, the sinker includes a series of cutout portions defined in the body and in communication with the line receiving channel, and the series of cutout portions are configured to receive the fishing line to allow for quick attachment and detachment of the sinker to the fishing line.

In some aspects, the series of cutout portions include a first cutout portion defined in the first end portion and a second cutout portion defined in the second end portion. The first and second cutout portions are both defined in the same side of the body of the sinker.

In some aspects, the series of cutout portions include a third cutout portion defined in between the first end portion and the main body portion. The third cutout portion extends transverse to the first cutout portion.

In some aspects, the series of cutout portions include a fourth cutout portion defined in between the second end portion and the main body portion. The fourth cutout portion extends transverse to the second cutout portion.

In some aspects, the series of cutout portions include a fifth cutout portion defined in the main body portion. The fifth cutout portion formed on an opposite side of the body as the first and second cutout portions.

In some aspects, the sleeve encloses one or more of the series of cutout portions to form a securing structure to ensure that the sinker remains attached to the fishing line.

In some aspects, the sinker includes an abutment structure positioned adjacent to the first end portion, and wherein the sleeve engages the abutment structure to restrict axial movement of the sleeve when the sleeve is coupled to the sinker.

In some aspects, the abutment structure is formed as a radial protrusion that extends at least partially around a circumference of the body of the sinker.

In some aspects, an alignment protrusion is positioned adjacent to the second end portion. The line receiving slot of the sleeve is sized to receive the alignment protrusion. The sleeve is configured to be translated along the body of the sinker until the sleeve engages the abutment structure.

In some aspects, the sleeve is configured to be rotated such that the alignment protrusion engages an inner surface of the sleeve, and the alignment protrusion engages the inner surface of the sleeve to provide a frictional fit with the sleeve to restrict axial movement of the sleeve relative to the sinker.

In some aspects, the disclosure relates to a sinker assembly configured to be coupled to a fishing line. The sinker assembly comprises a sinker including a body having a first end portion, a second end portion opposite the first end portion, and a main body portion connecting the first and second end portions. The body being constructed of a material with a first galvanic corrosion potential in salt water. The sinker includes an abutment structure positioned adjacent to the first end portion and a line receiving channel extending along a longitudinal axis of the body between the first end portion and the second end portion. The sinker assembly also comprises a sleeve removably coupled to the body of the sinker. The sleeve includes a body portion defining a receiving aperture that is sized to receive the body of the sinker. The body portion of the sleeve engages the abutment structure of the sinker to selectively secure the sleeve to the sinker. The body portion being formed of a material with a second galvanic corrosion potential in the salt water that is different from the first galvanic corrosion potential. The difference between the first galvanic corrosion potential of the sinker and the second galvanic corrosion potential of the sleeve results in a voltage gradient in the salt water that stimulates an electrosensory system of an electrosensitive organism in the salt water.

In some aspects, the sleeve engages the abutment structure to restrict axial movement of the sleeve when the sleeve is coupled to the sinker.

In some aspects, the abutment structure is formed as a radial protrusion that extends at least partially around a circumference of the body of the sinker.

In some aspects, an alignment protrusion is positioned adjacent to the second end portion of the sinker, the sleeve includes a line receiving slot that is sized to receive the alignment protrusion, and the sleeve is configured to be translated along the body of the sinker until the sleeve engages the abutment structure.

In some aspects, the sleeve is configured to be rotated such that the alignment protrusion engages an inner surface of the sleeve, and the alignment protrusion engages the inner surface of the sleeve to provide a frictional fit with the sleeve to restrict axial movement of the sleeve relative to the sinker.

In some aspects, the disclosure relates to a sinker configured to be coupled to a fishing line. The sinker includes a body having a first end portion, a second end portion opposite the first end portion, and a main body portion connecting the first end portion and the second end portion. The sinker includes a longitudinal axis extending centrally through the first end portion and the second end portion, a line receiving channel extending along the longitudinal axis between the first and second end portions, and a series of cutout portions defined in the body and in communication with the line receiving channel. The series of cutout portions are configured to receive the fishing line to allow for quick attachment and detachment of the sinker to the fishing line.

In some aspects, the sinker includes a series of cutout portions defined in the body and in communication with the line receiving channel, and the series of cutout portions are configured to receive the fishing line to allow for quick attachment and detachment of the sinker to the fishing line.

In some aspects, the series of cutout portions include a first cutout portion defined in the first end portion and a second cutout portion defined in the second end portion. The first and second cutout portions are both defined in the same side of the body of the sinker.

In some aspects, the series of cutout portions include a third cutout portion defined in between the first end portion and the main body portion. The third cutout portion extends transverse to the first cutout portion.

In some aspects, the series of cutout portions include a fourth cutout portion defined in between the second end portion and the main body portion. The fourth cutout portion extends transverse to the second cutout portion.

In some aspects, the series of cutout portions include a fifth cutout portion defined in the main body portion. The fifth cutout portion formed on an opposite side of the body as the first and second cutout portions.

In some aspects, the sinker includes a securing structure configured to selectively extend across one or more of the series of cutout portions after the fishing line is supported within line receiving channel.

In some aspects, the body is formed of a combination of a first material that has a first galvanic corrosion potential in salt water and a second material that has a second galvanic corrosion potential in the salt water that is different from the first galvanic corrosion potential, and wherein the difference between the first galvanic corrosion potential and the second galvanic corrosion potential results in a voltage gradient in the salt water that stimulates an electrosensory system of an electrosensitive organism in the salt water.

In some aspects, the first end portion and the second end portion are formed of the first material and the main body portion is formed of the second material.

In some aspects, the main body portion includes a series of ribs defined thereon, and the series of ribs increases a surface area of the main body portion of the sinker to increase the voltage gradient provided by the sinker.

In some aspects, the body is formed of the first material and an outer surface of the body is coated with the second material.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a sinker according to an implementation of the disclosure.

FIG. 2 is another perspective view of the sinker of FIG. 1, illustrating a line receiving channel.

FIG. 3 is a top view of the sinker of FIG. 1, illustrating the line receiving channel.

FIG. 4 is a cross-sectional perspective view of the sinker of FIG. 1, illustrating the line receiving channel.

FIG. 5 illustrates a fishing hook and the sinker of FIG. 1 coupled to a fishing line.

FIG. 6 illustrates the general configuration of gear for a pelagic longline fishing vessel.

FIG. 7A illustrates the voltage produced by equal size Zinc/Graphite and Neodymium samples in seawater at various distances from a recording electrode.

FIG. 7B illustrates the voltage provided by the sinker in relation to the distance from the sinker for three different amounts of times that the sinker is in the salt water.

FIG. 7C illustrates the voltage of the sinker in relation to the distance from the sinker for four different amounts of constructions of the sinker is in the salt water.

FIG. 8 is a perspective exploded view of a sinker assembly according to another implementation of the disclosure, illustrating a sinker and a sleeve.

FIG. 9 is a perspective view of the sinker of FIG. 8, illustrating a line receiving channel.

FIG. 10 illustrates a fishing hook and the sinker assembly of FIG. 8 coupled to a fishing line.

FIG. 11 is a top view of the sinker assembly of FIG. 8, illustrating the line receiving channel.

FIG. 12 is a perspective view of a sinker according to another implementation of the disclosure.

FIG. 13 is a perspective view of a sinker according to another implementation of the disclosure.

FIG. 14 is another perspective view of the sinker of FIG. 13.

FIG. 15 is a perspective view of a sinker according to another implementation of the disclosure.

FIG. 16 is a perspective view of a sleeve according to another implementation of the disclosure.

FIG. 17 is a top view of the sleeve of FIG. 16.

FIG. 18 is a perspective view of a sleeve according to another implementation of the disclosure.

FIG. 19 is a side view of the sleeve of FIG. 18.

FIG. 20 is a top view of the sleeve of FIG. 18.

### DETAILED DESCRIPTION

Before turning to the figures, which illustrate the exemplary implementations in detail, it should be understood that the present application is not limited to the details or methodology set forth in the description or illustrated in the figures. It should also be understood that the terminology is for the purpose of description only. Like reference numerals in the figures may represent and refer to the same or similar element, feature, or function.

The present disclosure is described with reference to the attached figures, wherein like reference numerals are used throughout the figures to designate similar or equivalent elements. The figures are not drawn to scale and they are provided merely to illustrate the instant disclosure. Several aspects of the disclosure are described below with reference to example applications for illustration. It should be understood that numerous specific details, relationships, and methods are set forth to provide a full understanding of the disclosure.

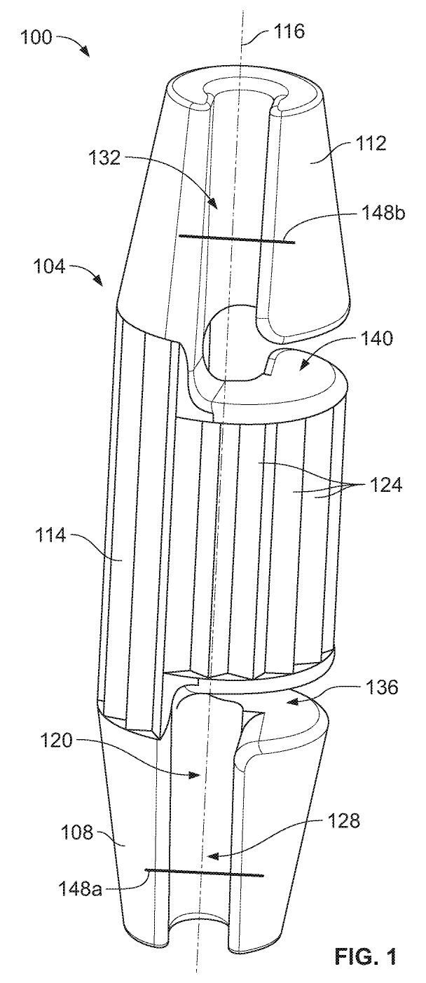

FIGS. 1-4 illustrate a sinker 100 according to an implementation of the disclosure. The sinker 100 is configured to be weighted to facilitate rapid sinking to keep the bait away from seabirds and aid with positioning of the bait at a desired depth. The sinker 100 includes a body 104 having a first end portion 108, a second end portion 112 opposite the first end portion 108, and a main body portion 114 connecting the first and second end portions 108, 112. The sinker 100 further defines a longitudinal axis 116 that extends centrally through the first and second end portions 108, 112 of the sinker 100. The body 104 defines a line receiving channel 120 that extends along the longitudinal axis 116 between the first and second end portions 108, 112. The line receiving channel 120 is configured to form a quick attachment and detachment mechanism that selectively receives the fishing line to attach the sinker to the fishing line.

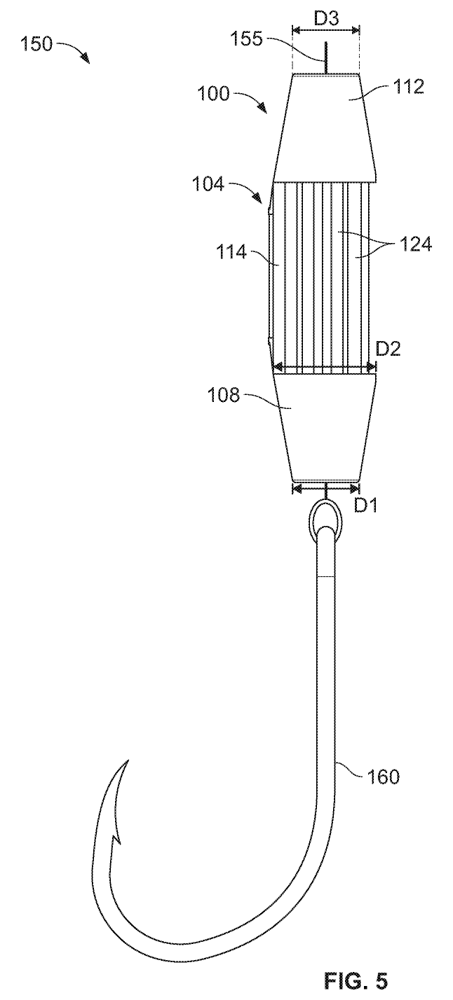

In the illustrated implementation, the first end portion 108 and the second end portion 112 of the body 104 are each tapered and are connected by a generally cylindrical portion defining the main body portion 114. For example, as shown in FIG. 5, the first end portion 108 tapers from a first diameter D1 to a second diameter D2, which defines the main body portion 114. The second end portion 112 tapers from the second diameter D2 to a third diameter D3. The first and third diameters D1, D3 are each less than the second diameter D2. In the illustrated implementation, the first and third diameters D1, D3 are equal to each other. The tapered construction of the first and second end portions 108, 112 improves the attachment of the sinker 100 to the fishing line and reduces snags on vegetation or the like in the water.

With reference to FIG. 1, the main body portion 114 includes a series of ribs 124 defined thereon. The construction of the ribs 124 increases a surface area of the main body portion 114 of the sinker 100. As described in more detail below, the increased surface area of the main body portion increases the voltage gradient provided by the sinker 100. Further, in the illustrated implementation, the body 104 of the sinker is formed of two different materials. For example, the first material has a first galvanic corrosion potential in salt water and the second material has a second galvanic corrosion potential in the salt water that is different from the first galvanic corrosion potential. The difference between the first galvanic corrosion potential and the second galvanic corrosion potential results in a voltage gradient in the salt water that stimulates an electrosensory system of an electrosensitive organism in the salt water.

In some implementations, the first and second end portions 108, 112 are formed of the first material and the main body portion 114 is formed of the second material. In other implementations, the body 104 may be formed of the first material and an outer surface of the body 104 may be coated with the second material. In other implementations, a core portion of the body 104 (e.g., extending between the first and second end portions 108, 112) may be formed of the first material and an outer portion of the body 104 (e.g., that surrounds the core portion) may be formed with the second material.

In some implementations, a core portion of the body 104 of the sinker 100 may be formed of a material such as plastic, tungsten, steel, or the like. An outer sleeve composed of the two different materials may be coupled to the core portion of the body 104. The outer sleeve may be composed of the two different reactive components to create the voltage gradient in the salt water that stimulates an electrosensory system of an electrosensitive organism in the salt water, which is discussed in more detail herein.

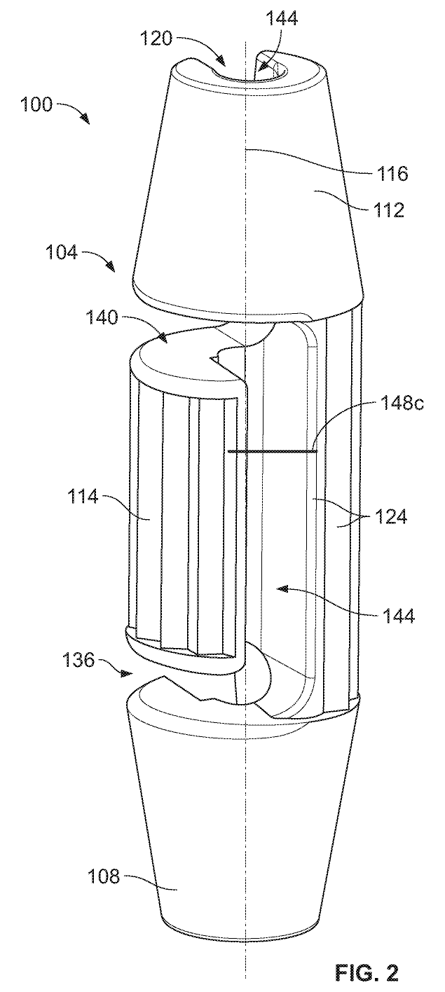

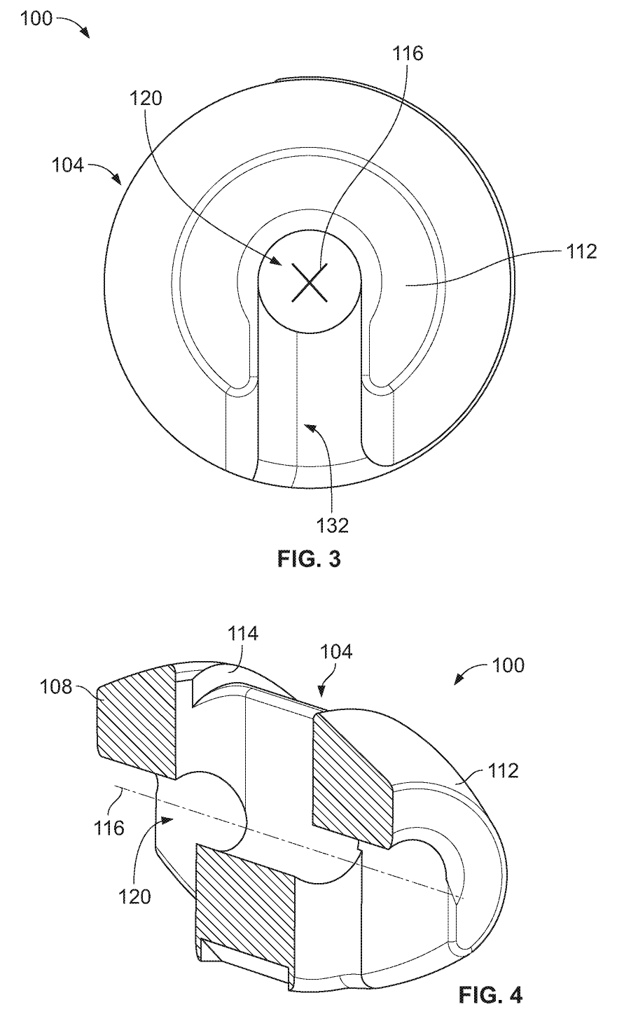

Now with reference to FIG. 1-4, the line receiving channel 120 defines a continuous channel (FIG. 3) that extends centrally through the body 104 from the first end portion 108 to the second end portion 112. The body 104 further includes a series of cutout portions 128 (FIG. 1), 132 (FIG. 1), 136 (FIG. 1), 140 (FIG. 1), 144 (FIG. 2) in communication with the line receiving channel 120 to allow for quick attachment and detachment of the sinker 100 to the fishing line. In the illustrated implementation, a first cutout portion 128 (FIG. 1) is defined in the first end portion 108 and a second cutout portion 132 (FIG. 1) is defined in the second end portion 112. The first and second cutout portions 128, 132 are both defined in the same side of the body 104 of the sinker 100. For example, the first and second cutout portions 128, 132 are both defined on a front side of the sinker 100 with respect to the perspective view shown in FIG. 1.

A third cutout portion 136 (FIG. 1) is defined in between the first end portion 108 and the main body portion 114. The third cutout portion 136 extends transverse to the first cutout portion 128 (e.g., towards a rear side of the sinker 100 with respect to the perspective view shown in FIG. 1). A fourth cutout portion 140 (FIG. 1) is defined in between the second end portion 112 and the main body portion 114. The fourth cutout portion 140 extends transverse to the second cutout portion 132 (e.g., towards a rear side of the sinker 100 with respect to the perspective view shown in FIG. 1). In other words, the third and fourth cutout portions 136, 140 each extend towards the rear side of the sinker 100.

Now with reference to FIG. 2, the third and fourth cutout portions 136, 140 are in communication with a fifth cutout portion 144 defined in the main body portion 114. The fifth cutout portion 144 is formed on an opposite side of the body 104 as the first and second cutout portions 128, 132. For example, the fifth cutout portion 144 is defined on a rear side of the sinker 100 with respect to the perspective view shown in FIG. 1. The series of cutout portions 128, 132, 136, 140, 144 are all in communication with the receiving channel 120, while providing internal support structures on opposite sides of the body 104 to allow for quick attachment and detachment of the sinker 100 to the fishing line.

In some implementations, a securing structure 148a (FIG. 1), 148b (FIG. 1), 148c (FIG. 2) may selectively extend across one or more of the cutout portions 128, 132, 144 after the fishing line is supported within the line receiving channel 120. The securing structure 148a, 148b, 148c is configured to restrict movement of the fishing line out of the line receiving channel 120 to ensure that the sinker 100 does not fall off the fishing line after the sinker 100 is attached. For example, the securing structure 148a, 148b 148c may be a hook latch, a pivot latch, or the like that is selectively secured after the sinker 100 is attached. In some implementations, the securing structure 148a may be on one side of the sinker (e.g., on the first and second cutout portions 128, 132 or on the fifth cutout portion 144). In other implementations, the sinker 100 may be devoid of any securing structure.

Now with reference to FIG. 5, a fishing hook and sinker assembly 150 is illustrated. The assembly includes a fishing line 155, a circle hook 160 which has been treated with a galvanic deterrent, and the sinker 100. The sinker 100 is constructed of a first material that has a first galvanic corrosion potential in salt water and a second material that has a second galvanic corrosion potential in the salt water that is different from the first galvanic corrosion potential. The difference between the first galvanic corrosion potential and the second galvanic corrosion potential results in a voltage gradient in the salt water that stimulates an electrosensory system of the electrosensitive organism in the salt water. The sinker 100 is movably coupled to the fishing line 155 just above the hook 160. In some implementations, multiple sinkers 100 may be coupled to the fishing line 155 adjacent to the hook 160.

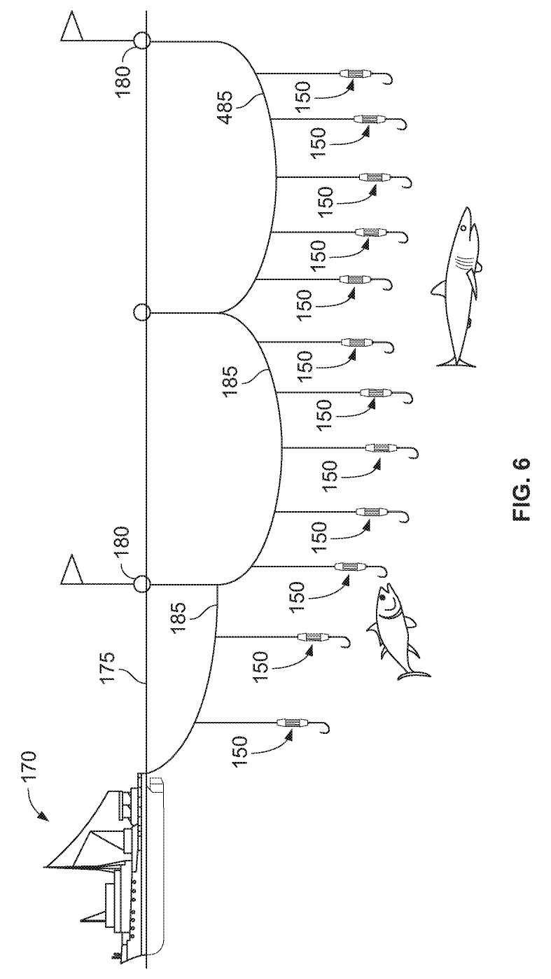

FIG. 6 illustrates the general configuration of gear 170 for a pelagic longline fishing vessel using the fishing hook and sinker assembly 150 illustrated in FIG. 5. A mainline 175 is deployed from a vessel with buoys 180 placed at determined distances along the length of the mainline 175. Between the buoys 180, gangions 185 are attached that consist of a tuna clip, and monofilament or wire leader terminating at the fishing hook and sinker assembly 150.

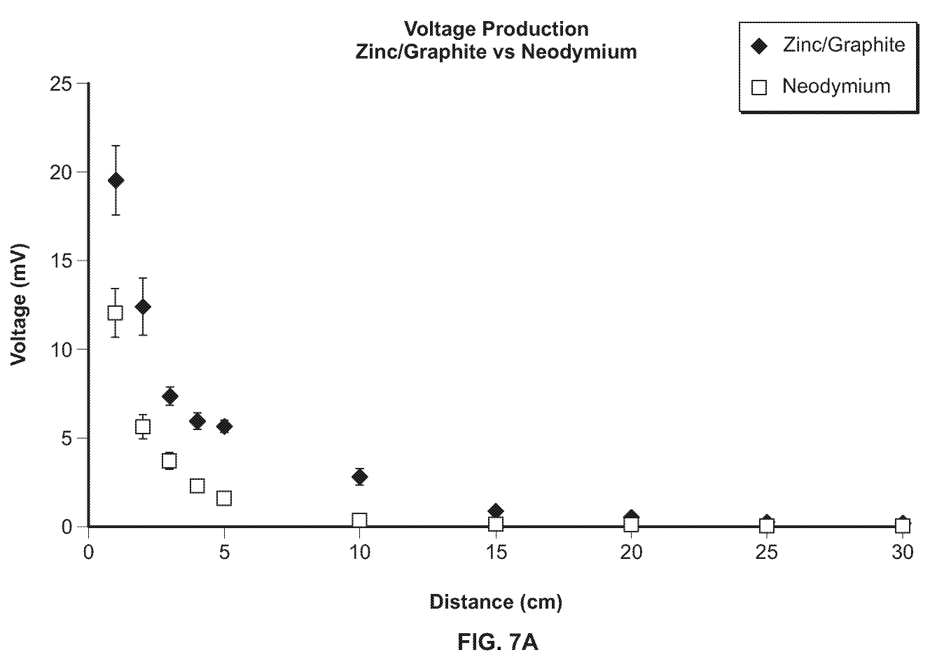

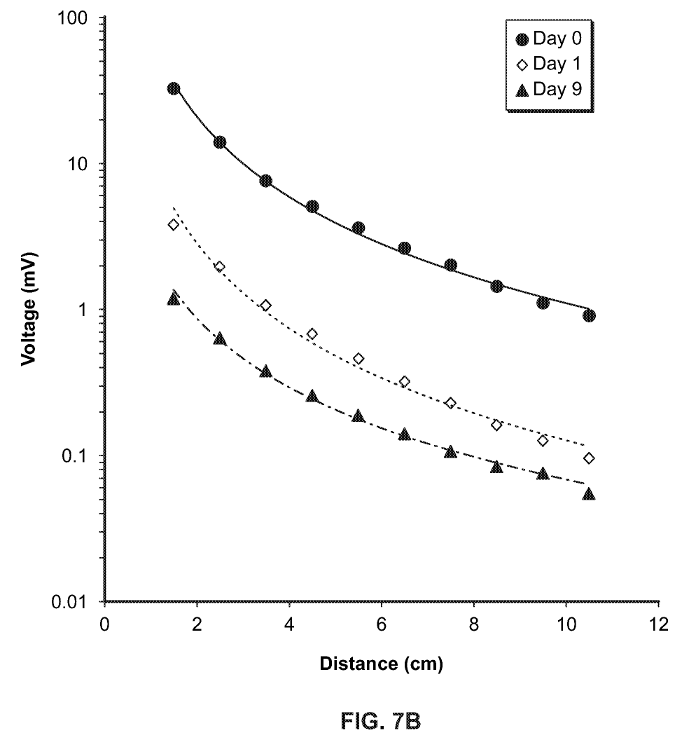

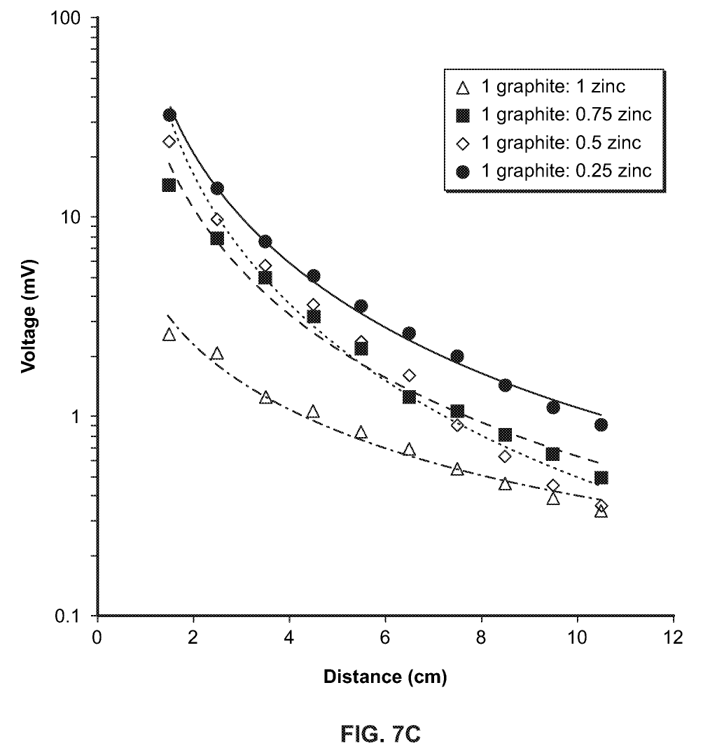

Now with reference to FIGS. 7A-7C, illustrate voltage production based on the construction of the sinker. For example, FIG. 7A compares the voltage of equal-sized samples of zinc/graphite and neodymium when the samples are positions within seawater. Treatments consisted of neodymium (99.5%, CSTRAM Advanced Materials Co., Shanghai, China), zinc (99.7%, McMaster Carr, Santa Fe Springs, Calif., USA), and GM-10 isomolded graphite (Graphtek LLC, Buffalo Grove, Ill., USA) cut into bricks measuring 5.08×5.08×0.635 cm. The voltage was measured from 2 juxtaposed neodymium (Nd) bricks, and for a brick of zinc (Zn) juxtaposed with a brick of graphite (Gr). To measure voltage, a sample was affixed to an acrylic arm on a vertical linear actuator which was mounted to a horizontal 300 mm eTrack linear translation stage (Newmark Systems Incorporated, Rancho Santa Margarita, Calif.) adjacent to an acrylic experimental tank (89×43×21 cm) equipped with flow-through seawater. This enabled precise placement of samples in the seawater at desired distances from a recording electrode mounted in the center of the tank. The recording electrode was a non-polarizable Ag—AgCl pellet electrode (E45P-M15NH, Warner Instruments, Hamden, Conn., USA) in 3.0 M KCl and fitted with a seawater/agar-filled glass capillary tube that terminated in a 100 μm diameter tip at mid-depth in the tank. A reference electrode was positioned in the far corner of the experimental tank. The output from the two electrodes was differentially amplified (DP-304, Warner Instruments, Hamden, Conn.) at 1000-10,000×, filtered (0.1 Hz-0.1 kHz, 60 Hz notch; DP-304, Warner Instruments & Hum Bug, Quest Scientific, North Vancouver, British Columbia), digitized at 1 kHz using a Power Lab® 16/30 model ML 880 (AD Instruments, Colorado Springs, Colo., USA) and recorded using Chart™ Software (v.5, AD Instruments). To measure the voltage, a sample was zip-tied to the non-conductive acrylic arm of the linear actuator. The sample was then translated to a position 1, 2, 3, 4, 5, 10, 15, 20, 25, or 30 cm from the recording electrode. The actuator then dipped the sample into the water and a voltage measurement was obtained. The actuator then removed the sample from the water, the sample was translated to one of the other randomly chosen distances, dipped again, and the process repeated until measurements were obtained at all distances from the recording electrode. Each sample was replaced after every cycle of measurements and 6 replicates were conducted for each treatment type. The replicate measurements were averaged and plotted against distance to determine the voltage decay with distance for the neodymium and zinc/graphite treatments. The results of voltage measurements conducted using the methods described above. Voltage produced by equally sized neodymium and zinc/graphite samples in seawater were not significantly different (ANOVA, F=2.39, p=0.1397).

FIG. 7B illustrates the voltage provided by the sinker 100 in relation to the distance from the sinker 100 for three different amounts of times that the sinker 100 is in the salt water. In particular, the closer to the sinker 100, the higher the voltage provided by the sinker 100. Further, the voltage of the sinker 100 decreases the amount of days the sinker 100 is in the salt water. FIG. 7C illustrates the voltage of the sinker 100 in relation to the distance from the sinker 100 for four different amounts of constructions of the sinker 100 is in the salt water. For example, increasing the ratio of graphite to zinc also increases the amount of voltage provided by the sinker 100.

As discussed above, the sinker 100 may be formed of the combination of zinc and graphite due to the efficiency of voltage provided from the combination of the materials. In some implementations, the ratio of zinc to graphite in the sinker 100 may be adjusted to provide a predetermined voltage.

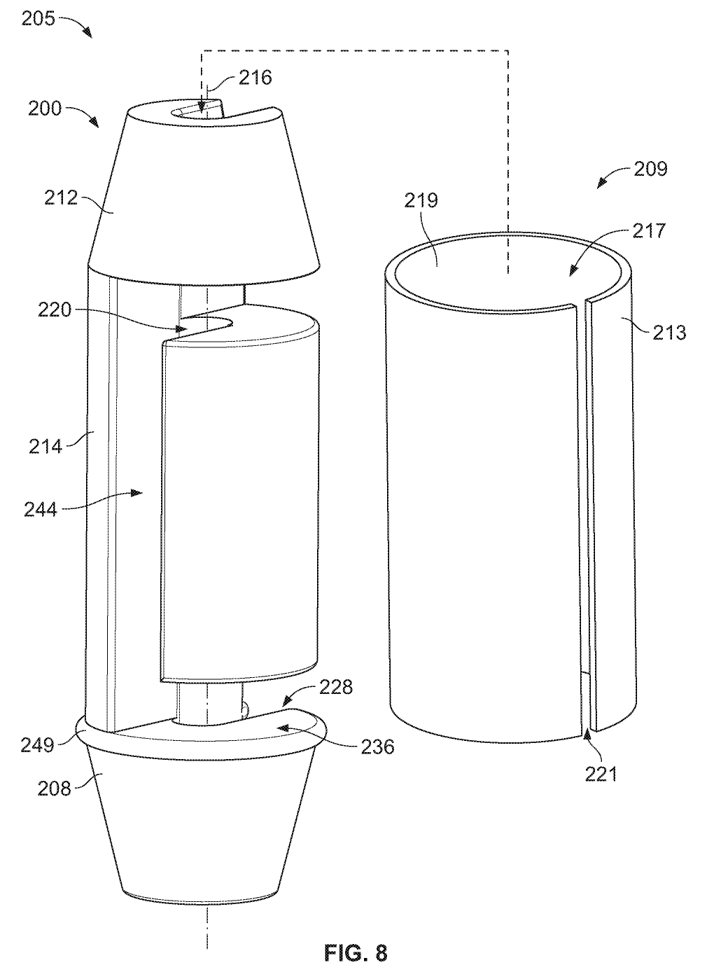

FIG. 8 illustrates a sinker assembly 205 according to an alternative implementation of the disclosure. The sinker assembly 205 comprises a sinker 200 similar to the sinker 100 described above with reference to FIGS. 1-7 and a sleeve 209 removably coupled to the sinker 200. The sinker assembly 205 is similar to the sinker 100 described above with reference to FIGS. 1-7, except as noted, and the following description focuses primarily on differences between the sinker assembly 205 and the sinker 200. In addition, common features and elements of the sinker assembly 205 corresponding with features and elements of the sinker 200 are given common reference numbers plus 100.

The sinker 200 includes a body 204 having a first end portion 208, a second end portion 212 opposite the first end portion 208, and a main body portion 214 connecting the first and second end portions 208, 212. The sinker 200 further defines a longitudinal axis 216 that extends centrally through the first and second end portions 208, 212 of the sinker 200. The body 204 defines a line receiving channel 220 that extends along the longitudinal axis 216 between the first and second end portions 208, 212. The line receiving channel 220 is configured to form a quick attachment and detachment mechanism that selectively receives the fishing line to attach the sinker to the fishing line.

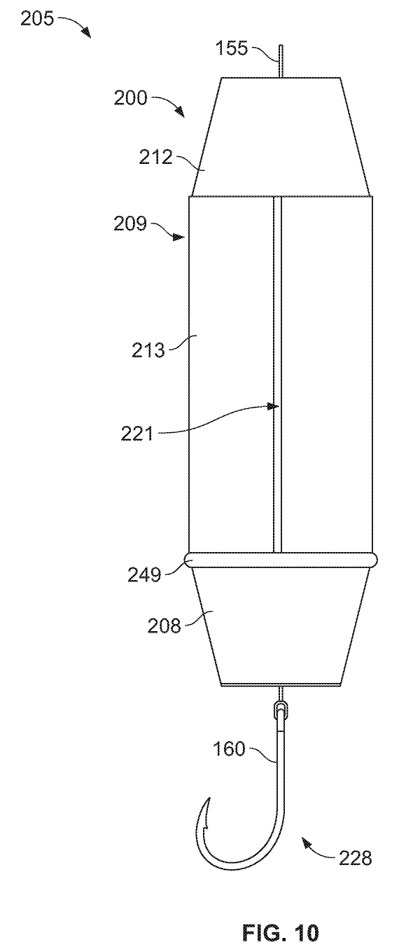

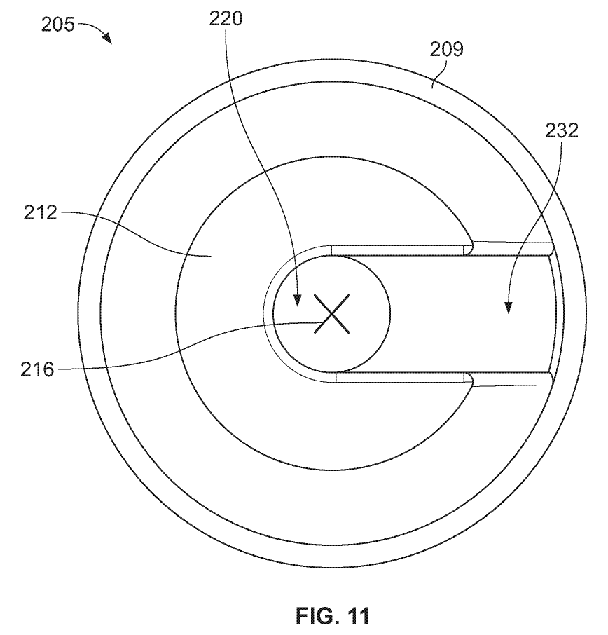

In the illustrated implementation, the first end portion 208 and the second end portion 212 of the body 204 are each tapered and are connected by a generally cylindrical portion defining the main body portion 214. The tapered construction of the first and second end portions 208, 212 improves the attachment of the sinker 200 to the fishing line and reduces snags on vegetation or the like in the water. In contrast to the sinker 100, which includes a series of ribs 124, the main body portion 214 of the sinker 200 has a substantially flat outer surface. Further, similar to the sinker 100, the line receiving channel 220 of the sinker 200 defines a continuous channel (FIG. 8) that extends centrally through the body 204 from the first end portion 208 to the second end portion 212. The body 204 further includes a series of cutout portions 228, 232, 236, 240, 244 in communication with the receiving channel 220 to allow for quick attachment and detachment of the sinker 200 to the fishing line (FIG. 10).

The sinker 200 further includes an abutment structure 249 positioned adjacent to the first end portion 208. In the illustrated implementation, the abutment structure 249 is a radial protrusion that extends at least partially around a circumference of the body 204 of the sinker 200. For example, the protrusion extends from the entire circumference outside of the portion of the body 204 that is removed to form the cutout portion 228. The abutment structure 249 provides a surface for the sleeve 209 to contact when the sleeve 209 is coupled to the sinker 200. The abutment structure 249 restricts axial movement of the sleeve 209 to secure the sleeve 209 to the sinker 200. In other implementations, the abutment structure 249 may have an alternative construction to selectively secure the sleeve 209 to the sinker 200. For example, the abutment structure 249 may comprise a plurality of spaced protrusions circumferentially spaced from each other, a tapered surface that increases the diameter of the body 204 prior to the first end portion 208, or the like.

In the illustrated implementation, the body 204 of the sinker 200 is constructed of a material with a first galvanic corrosion potential in salt water. For example, the sinker 200 may be formed of graphite, have a substantial volume of graphite, or comprise other cathodic material. The graphite may be solid, suspended in plastic with graphite exposed to the seawater, or comprise a low-density graphite matrix. In other implementations, the sinker 200 may be formed of a material such as ultra-thin graphite sponge (UtGS) or foam.

The sleeve 209 is removably coupled to the sinker 200. The sleeve 209 comprises a body portion 213 having a generally cylindrical construction. The body portion 213 of the sleeve 209 defines a receiving aperture 217 that is sized to receive the body 204 of the sinker 200. The body portion 213 defines an inner surface 219 that engages a portion of the sinker 200 when the sleeve 209 is coupled to the sinker 200. The sleeve 209 further comprises a line receiving slot 221 extending along a length of the body portion 213. The line receiving slot 221 allows the sleeve 209 to be inserted onto a fishing line 155 (FIG. 10) after the sinker 200 is coupled to the fishing line 155. The construction of the sinker 200 and the sleeve 209 facilitates quick attachment and detachment of the sinker 200 and the sleeve 209 to the fishing line. Further, the sleeve 209 may form a securing structure to ensure that the sinker 200 remains attached to the fishing line 155. For example, the sleeve 209 may enclose one or more of the cutout portions 228, 232, 244 after the fishing line is supported within the line receiving channel 220.

In the illustrated implementation, the sleeve 209 is formed of a material with a second galvanic corrosion potential in salt water. For example, the sleeve 209 may be formed of zinc, contain a substantial volume of zinc, or comprise other anodic material. In some implementations, the sleeve 209 may be formed as a solid tube, a porous foam, a mesh, or a layered mesh to provide a large surface area for reaction. The difference between the first galvanic corrosion potential of the sinker 200 and the second galvanic corrosion potential of the sleeve 209 results in a voltage gradient in the salt water that stimulates an electrosensory system of an electrosensitive organism in the salt water.

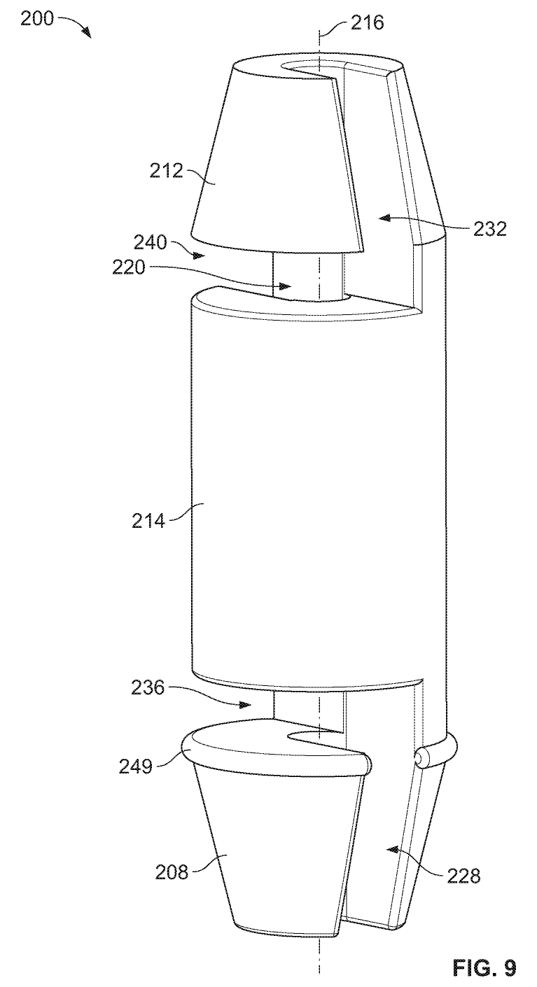

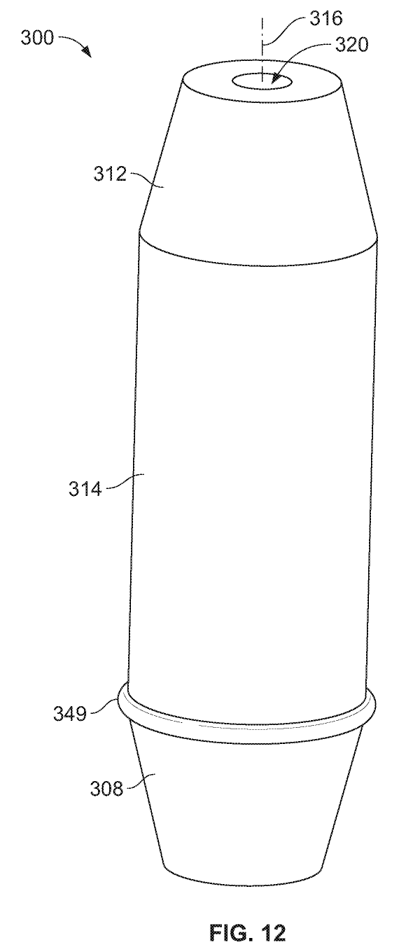

FIG. 12 illustrates a sinker 300 according to an alternative implementation of the disclosure. The sinker 300 is similar to the sinker 100 and the sinker 200 described above with reference to FIGS. 1-11, except as noted, and the following description focuses primarily on differences between the sinker 300 and the sinkers 100, 200. In addition, common features and elements of the sinker 300 corresponding with features and elements of the sinkers 100, 200 are given common reference numbers plus 100 or 200. It should also be appreciated that the sleeve 209 may be used with the sinker 300 in a similar fashion as described above.

The sinker 300 includes a body 304 having a first end portion 308, a second end portion 312 opposite the first end portion 308, and a main body portion 314 connecting the first and second end portions 308, 312. The sinker 300 further defines a longitudinal axis 316 that extends centrally through the first and second end portions 308, 312 of the sinker 300. The body 304 defines a line receiving channel 320 that extends along the longitudinal axis 316 between the first and second end portions 308, 312. In contrast to the sinkers 100, 200, which have a quick attachment and detachment mechanism that selectively receives the fishing line to attach the sinker to the fishing line, the sinker 300 is coupled to the fishing line prior to coupling the hook to the fishing line. In such an implementation, one or both of the first end portion 308 or the second end portion 312 may be clamped to secure the sinker 300 to the fishing line.

The sinker 300 further includes an abutment structure 349 positioned adjacent to the first end portion 308. In the illustrated implementation, the abutment structure 349 is a radial protrusion that extends circumferentially around the body 304 of the sinker 300. The abutment structure 349 provides a surface for the sleeve 209 to contact. The abutment structure 349 restricts axial movement of the sleeve 209 to secure the sleeve 209 to the sinker 300. In other implementations, the abutment structure 349 may have an alternative construction to selectively secure the sleeve 209 to the sinker 300. For example, the abutment structure 349 may comprise a plurality of spaced protrusions circumferentially spaced from each other, a tapered surface that increases the diameter of the body 304 prior to the first end portion 308, or the like. Similar to the sinker 200, the difference between the first galvanic corrosion potential of the sinker 300 and the second galvanic corrosion potential of the sleeve 209 results in a voltage gradient in the salt water that stimulates an electrosensory system of an electrosensitive organism in the salt water.

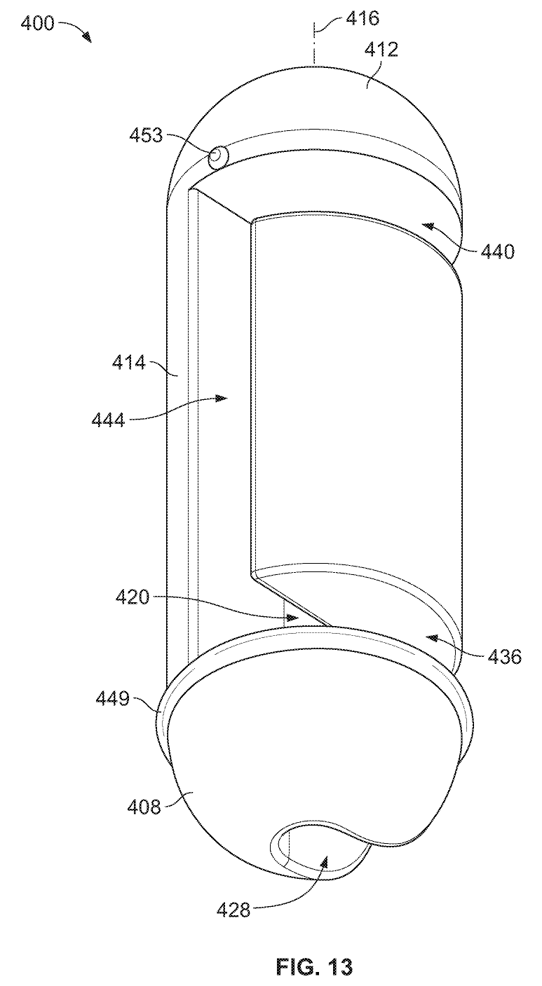

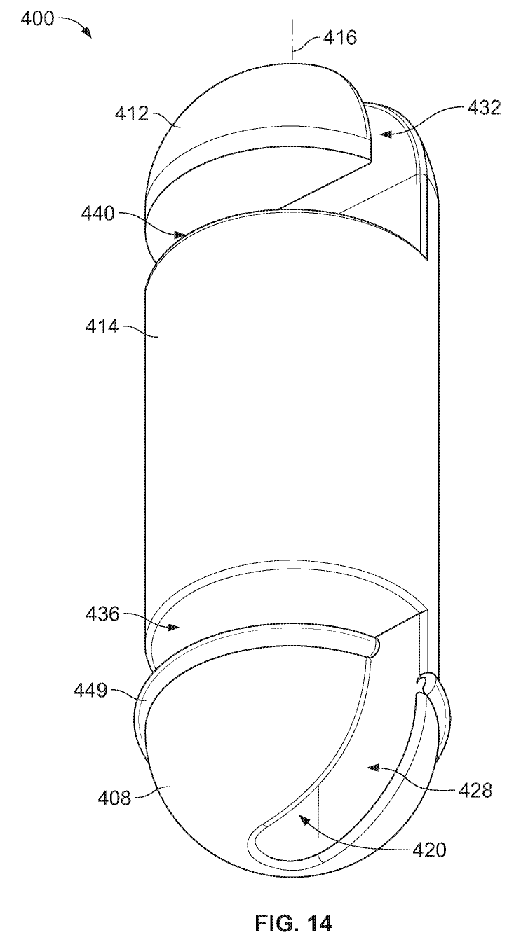

FIGS. 13 and 14 illustrate a sinker 400 according to an alternative implementation of the disclosure. The sinker 400 is similar to the sinkers 100, 200, 300 described above with reference to FIGS. 1-12, except as noted, and the following description focuses primarily on differences between the sinker 400 and the sinkers 100, 200, 300. In addition, common features and elements of the sinker 400 corresponding with features and elements of the sinkers 100, 200, 300 are given common reference numbers plus 100, 200, or 300. It should also be appreciated that the sleeve 209 may be used with the sinker 400 in a similar fashion as described above.

The sinker 400 includes a body 404 having a first end portion 408, a second end portion 412 opposite the first end portion 408, and a main body portion 414 connecting the first and second end portions 408, 412. In contrast to the sinkers 100, 200, 300 which have tapered end portions, the end portions 408, 412 are rounded. The sinker 400 further defines a longitudinal axis 416 that extends centrally through the first and second end portions 408, 412 of the sinker 400. The body 404 defines a line receiving channel 420 that extends along the longitudinal axis 416 between the first and second end portions 408, 412. Similar to the sinkers 100, 200, the body 404 further includes a series of cutout portions 428, 432, 436, 440, 444 in communication with the receiving channel 420 to allow for quick attachment and detachment of the sinker 400 to the fishing line.

The sinker 400 further includes an abutment structure 449 positioned adjacent to the first end portion 408. In addition, an alignment protrusion 453 is positioned adjacent to the second end portion 412. In the illustrated implementation, the abutment structure 449 is a radial protrusion that extends circumferentially around the body 304 of the sinker 300. During assembly of the sinker assembly, the sinker 400 is attached to the fishing line. Once the sinker 300 is attached to the fishing line, the line receiving slot 221 of the sleeve 209 is aligned with the alignment protrusion 453 and is translated along the body 404 of the sinker until the sleeve 209 engages the abutment structure 449. Once the sleeve contacts the abutment structure 449, the sleeve 209 may be rotated such that the alignment protrusion 453 engages an inner surface of the sleeve 209. In some implementations, the alignment protrusion 453 provides a frictional fit to restrict axial movement of the sleeve 209 relative to the sinker 400. Similar to the sinkers 200, 300, the difference between the first galvanic corrosion potential of the sinker 400 and the second galvanic corrosion potential of the sleeve 209 results in a voltage gradient in the salt water that stimulates an electrosensory system of an electrosensitive organism in the salt water.

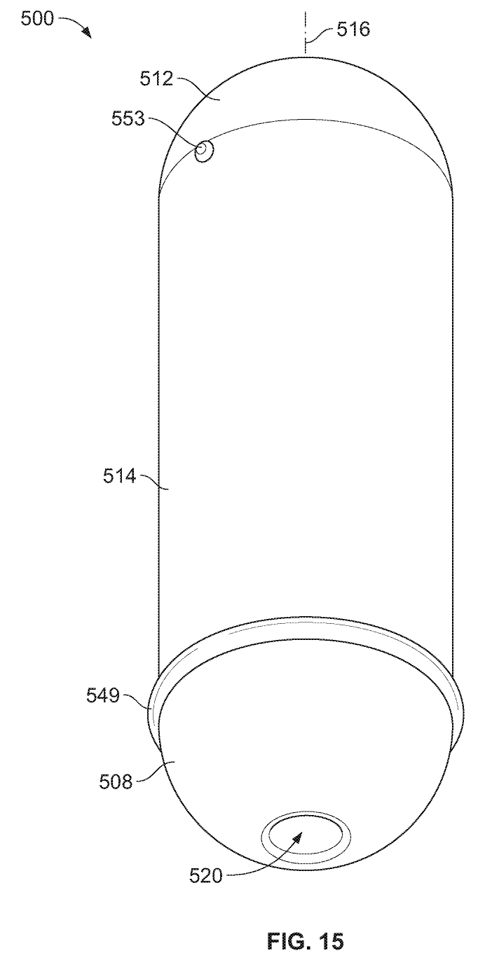

FIG. 15 illustrates a sinker 500 according to an alternative implementation of the disclosure. The sinker 500 is similar to the sinkers 100, 200, 300, 400 described above with reference to FIGS. 1-14, except as noted, and the following description focuses primarily on differences between the sinker 500 and the sinkers 100, 200, 300, 400. In addition, common features and elements of the sinker 500 corresponding with features and elements of the sinkers 100, 200, 300, 400 are given common reference numbers plus 100, 200, 300, 400. It should also be appreciated that the sleeve 209 may be used with the sinker 500 in a similar fashion as described above.

The sinker 500 includes a body 504 having a first end portion 508, a second end portion 512 opposite the first end portion 508, and a main body portion 514 connecting the first and second end portions 508, 512. In contrast to the sinkers 100, 200, 300, which have tapered end portions, the end portions 508, 512 are rounded. The sinker 500 further defines a longitudinal axis 516 that extends centrally through the first and second end portions 508, 512 of the sinker 500. The body 504 defines a line receiving channel 520 that extends along the longitudinal axis 516 between the first and second end portions 508, 512. In contrast to the sinkers 100, 200, 400, which have a quick attachment and detachment mechanism that selectively receives the fishing line to attach the sinker to the fishing line, the sinker 500 is coupled to the fishing line prior to coupling the hook to the fishing line. In such an implementation, one or both of the first end portion 508 or the second end portion 512 may be clamped to secure the sinker 500 to the fishing line.

The sinker 500 further includes an abutment structure 549 positioned adjacent to the first end portion 508. In addition, an alignment protrusion 553 is positioned adjacent to the second end portion 512. In the illustrated implementation, the abutment structure 549 is a radial protrusion that extends circumferentially around the body 504 of the sinker 500. During assembly of the sinker assembly, the sinker 500 is attached to the fishing line. Once the sinker 500 is attached to the fishing line, the line receiving slot 221 of the sleeve 209 is aligned with the alignment protrusion 553 and is translated along the body 504 of the sinker 500 until the sleeve 209 engages the abutment structure 549. Once the sleeve 209 contacts the abutment structure 549, the sleeve 209 may be rotated such that the alignment protrusion 553 engages an inner surface of the sleeve 209. In some implementations, the alignment protrusion 553 provides a frictional fit to restrict axial movement of the sleeve 209 relative to the sinker 500. Similar to the sinkers 200, 300, 400, the difference between the first galvanic corrosion potential of the sinker 500 and the second galvanic corrosion potential of the sleeve 209 results in a voltage gradient in the salt water that stimulates an electrosensory system of an electrosensitive organism in the salt water.

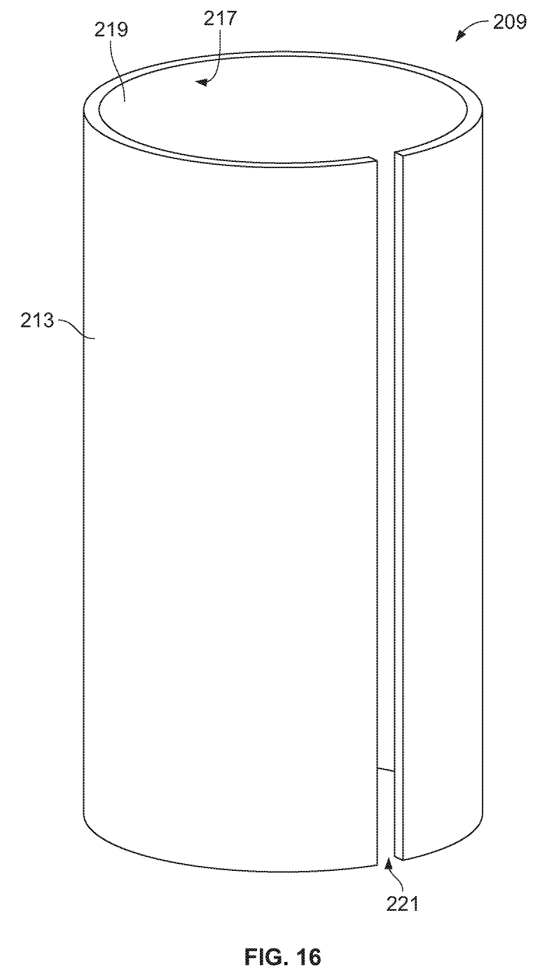

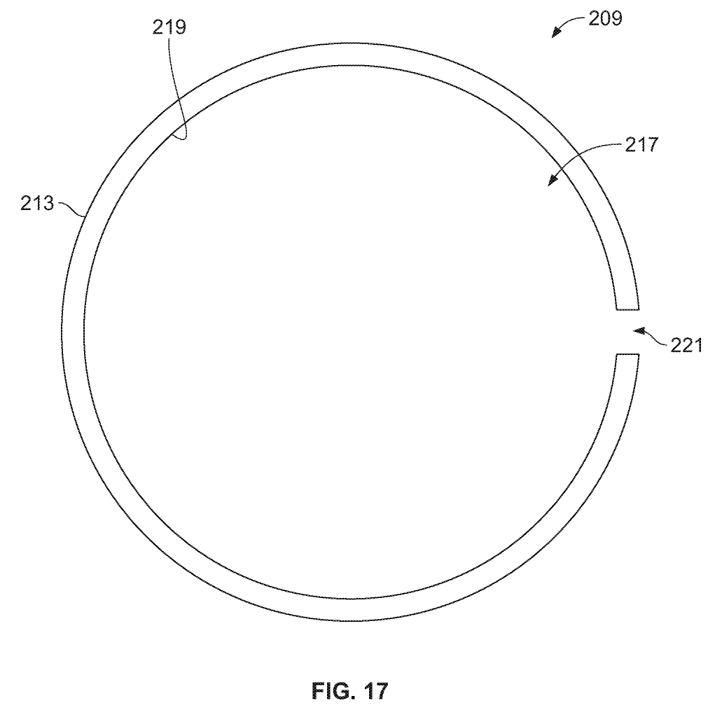

Now with reference to FIGS. 16 and 17, the sleeve 209 is illustrated in more detail. It should be appreciated that the sleeve 209 may be used with any of the sinkers 100, 200, 300, 400, 500 described herein. The sleeve 209 comprises a body portion 213 having a generally cylindrical construction. The body portion 213 of the sleeve 209 defines a receiving aperture 217 that is sized to receive the body 204 of the sinker 100, 200, 300, 400, 500. The sleeve 209 further comprises a line receiving slot 221 extending along a length of the body portion 213. The line receiving slot 221 allows the sleeve 209 to be inserted onto a fishing line after the sinker 100, 200, 300, 400, 500 is coupled to the fishing line.

In the illustrated implementation, the sleeve 209 is formed of a material with a second galvanic corrosion potential in salt water. For example, the sleeve may be formed of zinc, contain a substantial volume of zinc, or comprise other anodic material. In some implementations, the sleeve 209 may be formed as a solid tube, a porous foam, a mesh, or a layered mesh to provide a large surface area for reaction. The difference between the first galvanic corrosion potential of the sinker 200 and the second galvanic corrosion potential of the sleeve 209 results in a voltage gradient in the salt water that stimulates an electrosensory system of an electrosensitive organism in the salt water.

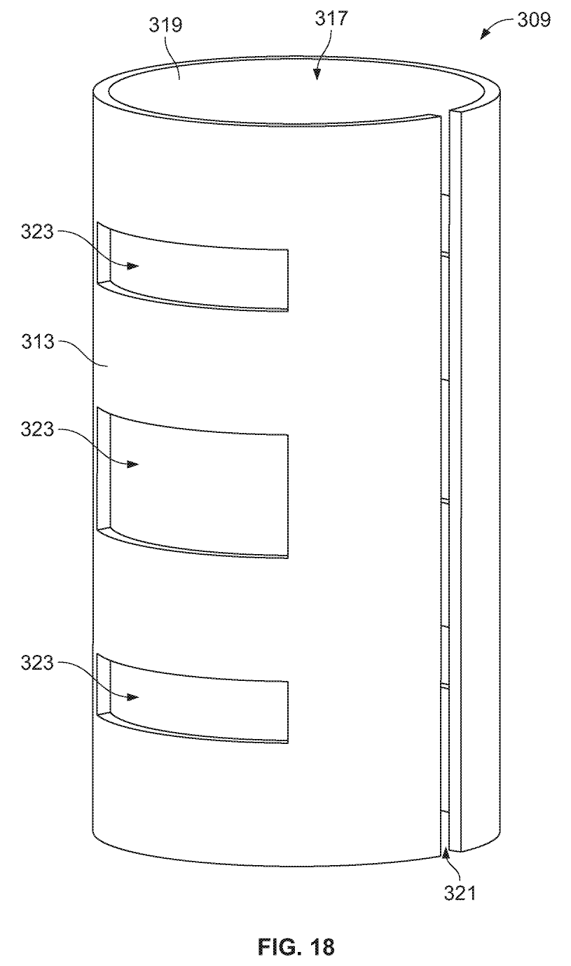

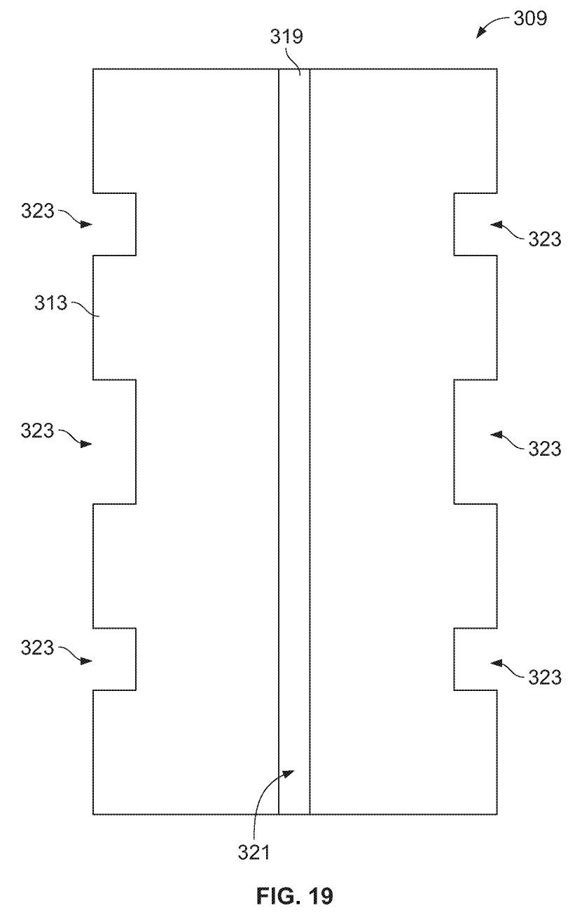

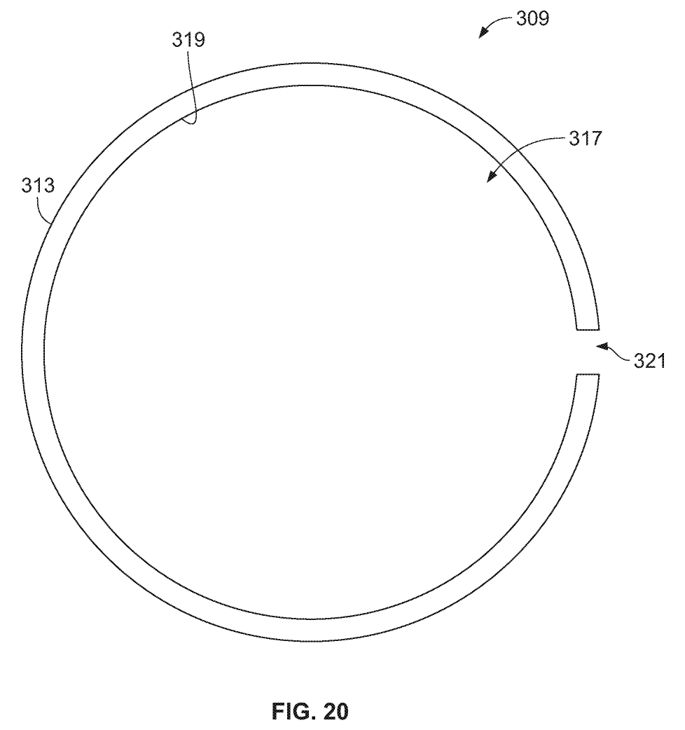

FIGS. 18-20 illustrate a sleeve 309 according to an alternative implementation of the disclosure. The sleeve 309 is similar to the sleeve 209 described above with reference to FIGS. 16-17, except as noted, and the following description focuses primarily on differences between the sleeve 309 and the sleeve 209. In addition, common features and elements of the sleeve 309 corresponding with features and elements of the sleeve 209 are given common reference numbers plus 100. It should also be appreciated that the sleeve 309 may be used with any of the sinkers 100, 200, 300, 400, 500 described herein.

The sleeve 309 comprises a body portion 313 having a generally cylindrical construction. The body portion 313 of the sleeve 309 defines a receiving aperture 317 that is sized to receive the body 304 of the sinkers 100, 200, 300, 400, 500. The sleeve 309 further comprises a line receiving slot 321 extending along a length of the body portion 313. The line receiving slot 321 allows the sleeve 309 to be inserted onto a fishing line after the sinker 100, 200, 300, 400, 500 is coupled to the fishing line. The sleeve 309 further comprises a plurality of windows 323 formed in the body portion 313. The windows 323 expose portions of the sinker 100, 200, 300, 400, 500.

In the illustrated implementation, the sleeve 309 is formed of a material with a second galvanic corrosion potential in salt water. For example, the sleeve 309 may be formed of zinc, contain a substantial volume of zinc, or comprise other anodic material. In some implementations, the sleeve 309 may be formed as a solid tube, a porous foam, a mesh, or a layered mesh to provide a large surface area for reaction. The difference between the first galvanic corrosion potential of the sinker 100, 200, 300, 400, 500 and the second galvanic corrosion potential of the sleeve 309 results in a voltage gradient in the salt water that stimulates an electrosensory system of an electrosensitive organism in the salt water.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

What is claimed is:

1. A sinker assembly configured to be coupled to a fishing line, the sinker assembly comprising:
a sinker comprising:
a body having a first end portion, a second end portion opposite the first end portion, and a main body portion connecting the first and second end portions, the body being constructed of a material with a first galvanic corrosion potential in salt water, and
a line receiving channel extending along a longitudinal axis of the body between the first end portion and the second end portion; and
a sleeve removably coupled to the body of the sinker, the sleeve comprising:
a body portion defining a receiving aperture that is sized to receive the body of the sinker, the body portion being formed of a material with a second galvanic corrosion potential in the salt water that is different from the first galvanic corrosion potential, wherein the difference between the first galvanic corrosion potential of the sinker and the second galvanic corrosion potential of the sleeve results in a voltage gradient in the salt water that stimulates an electrosensory system of an electrosensitive organism in the salt water, and
a line receiving slot extending along a length of the body portion, the line receiving slot configured to receive the fishing line to facilitate attachment of the sleeve to the sinker.

2. The sinker assembly of claim 1, wherein:
the sinker comprises a series of cutout portions defined in the body and in communication with the line receiving channel, and
the series of cutout portions are configured to receive the fishing line to allow for quick attachment and detachment of the sinker to the fishing line.

3. The sinker assembly of claim 2, wherein the series of cutout portions comprise:
a first cutout portion defined in the first end portion,
a second cutout portion defined in the second end portion, the first and second cutout portions are both defined in the same side of the body of the sinker,
a third cutout portion defined in between the first end portion and the main body portion, the third cutout portion extending transverse to the first cutout portion,
a fourth cutout portion defined in between the second end portion and the main body portion, the fourth cutout portion extending transverse to the second cutout portion, and
a fifth cutout portion defined in the main body portion, the fifth cutout portion formed on an opposite side of the body as the first and second cutout portions.

4. The sinker assembly of claim 2, wherein the sleeve encloses one or more of the series of cutout portions to form a securing structure to ensure that the sinker remains attached to the fishing line.

5. The sinker assembly of claim 1, wherein the sinker comprises an abutment structure positioned adjacent to the first end portion, and wherein the sleeve engages the abutment structure to restrict axial movement of the sleeve when the sleeve is coupled to the sinker.

6. The sinker assembly of claim 5, wherein the abutment structure is formed as a radial protrusion that extends at least partially around a circumference of the body of the sinker.

7. The sinker assembly of claim 5, wherein:
an alignment protrusion is positioned adjacent to the second end portion,
the line receiving slot of the sleeve is sized to receive the alignment protrusion, and
the sleeve is configured to be translated along the body of the sinker until the sleeve engages the abutment structure.

8. The sinker assembly of claim 7, wherein:
the sleeve is configured to be rotated such that the alignment protrusion engages an inner surface of the sleeve, and
the alignment protrusion engages the inner surface of the sleeve to provide a frictional fit with the sleeve to restrict axial movement of the sleeve relative to the sinker.

9. A sinker assembly configured to be coupled to a fishing line, the sinker assembly comprising:
a sinker comprising:
a body having a first end portion, a second end portion opposite the first end portion, and a main body portion connecting the first and second end portions, the body being constructed of a material with a first galvanic corrosion potential in salt water,
an abutment structure positioned adjacent to the first end portion, and
a line receiving channel extending along a longitudinal axis of the body between the first end portion and the second end portion; and
a sleeve removably coupled to the body of the sinker, the sleeve comprising:
a body portion defining a receiving aperture that is sized to receive the body of the sinker, the body portion of the sleeve engages the abutment structure of the sinker to selectively secure the sleeve to the sinker, the body portion being formed of a material with a second galvanic corrosion potential in the salt water that is different from the first galvanic corrosion potential,
wherein the difference between the first galvanic corrosion potential of the sinker and the second galvanic corrosion potential of the sleeve results in a voltage gradient in the salt water that stimulates an electrosensory system of an electrosensitive organism in the salt water.

10. The sinker assembly of claim 9, wherein the sleeve engages the abutment structure to restrict axial movement of the sleeve when the sleeve is coupled to the sinker.

11. The sinker assembly of claim 9, wherein the abutment structure is formed as a radial protrusion that extends at least partially around a circumference of the body of the sinker.

12. The sinker assembly of claim 9, wherein:
an alignment protrusion is positioned adjacent to the second end portion of the sinker,
the sleeve comprises a line receiving slot that is sized to receive the alignment protrusion, and
the sleeve is configured to be translated along the body of the sinker until the sleeve engages the abutment structure.

13. The sinker assembly of claim 12, wherein:
the sleeve is configured to be rotated such that the alignment protrusion engages an inner surface of the sleeve, and
the alignment protrusion engages the inner surface of the sleeve to provide a frictional fit with the sleeve to restrict axial movement of the sleeve relative to the sinker.

14. A sinker configured to be coupled to a fishing line, the sinker comprising:
a body having a first end portion, a second end portion opposite the first end portion, and a main body portion connecting the first end portion and the second end portion;
a longitudinal axis extending centrally through the first end portion and the second end portion;
a line receiving channel extending along the longitudinal axis between the first and second end portions; and
a series of cutout portions defined in the body and in communication with the line receiving channel,
wherein the series of cutout portions are configured to receive the fishing line to allow for quick attachment and detachment of the sinker to the fishing line.

15. The sinker of claim 14, wherein the series of cutout portions comprise:
a first cutout portion defined in the first end portion,
a second cutout portion defined in the second end portion, wherein the first and second cutout portions are both defined in the same side of the body of the sinker,
a third cutout portion defined in between the first end portion and main body portion, wherein the third cutout portion extends transverse to the first cutout portion,
a fourth cutout portion defined in between the second end portion and main body portion, wherein the fourth cutout portion extends transverse to the second cutout portion, and
a fifth cutout portion defined in the main body portion, wherein the fifth cutout portion is formed on an opposite side of the body as the first and second cutout portions.

16. The sinker of claim 14, further comprising a securing structure configured to selectively extend across one or more of the series of cutout portions after the fishing line is supported within line receiving channel.

17. The sinker of claim 14, wherein the body is formed of a combination of a first material that has a first galvanic corrosion potential in salt water and a second material that has a second galvanic corrosion potential in the salt water that is different from the first galvanic corrosion potential, and wherein the difference between the first galvanic corrosion potential and the second galvanic corrosion potential results in a voltage gradient in the salt water that stimulates an electrosensory system of an electrosensitive organism in the salt water.

18. The sinker of claim 17, wherein the first end portion and the second end portion are formed of the first material and the main body portion is formed of the second material.

19. The sinker of claim 18, wherein the main body portion includes a series of ribs defined thereon, and wherein the series of ribs increases a surface area of the main body portion of the sinker to increase the voltage gradient provided by the sinker.

20. The sinker of claim 18, wherein the body is formed of the first material and an outer surface of the body is coated with the second material.
